(19) United States
(12) Patent Application Publication
(10) Pub. No.: US 2012/0014214 A1
(43) Pub. Date: Jan. 19, 2012

(54) TIME REVERSE IMAGING OPERATORS FOR SOURCE LOCATION WITH BOREHOLE DATA

(75) Inventors: Brad Artman, Denver, CO (US); Erik Saenger, Wetzikon (CH); Brian Steiner, Zurich (CH); Benjamin Witten, Denver, CO (US)

(73) Assignee: SPECTRASEIS AG, ZURICH (CH)

(21) Appl. No.: 13/244,672

(22) Filed: Sep. 25, 2011

Related U.S. Application Data
(63) Continuation of application No. 13/145,305, filed on Jul. 19, 2011.
(60) Provisional application No. 61/145,865, filed on Jan. 20, 2009.
(60) Provisional application No. 61/228,602, filed on Jul. 26, 2009.

(51) Int. Cl. G01V 1/40

(52) U.S. Cl. 367/25

(57) ABSTRACT

A method and system for processing synchronous array seismic data includes acquiring synchronous passive seismic data from a plurality of sensors to obtain synchronized array measurements. A reverse-time data propagation process is applied to the synchronized array measurements to obtain a plurality of dynamic particle parameters associated with subsurface locations. Imaging conditions are applied to the dynamic particle parameters to obtain image values associated with subsurface energy source locations.

### BACKGROUND OF THE DISCLOSURE

1. Technical Field

The disclosure is related to seismic exploration for oil and gas, and more particularly to determination of the positions of subsurface reservoirs.

2. Description

Geophysical and geological exploration investment for hydrocarbons is often focused on acquiring data in the most promising areas using relatively slow methods, such as reflection seismic data acquisition and processing. The acquired data are used for mapping potential hydrocarbon-bearing areas within a survey area to optimize exploratory or production well locations and to minimize costly non-productive wells.

The time from mineral discovery to production may be shortened if the total time required to evaluate and explore a survey area can be reduced by applying geophysical methods alone or in combination. Some methods may be used as a standalone decision tool for oil and gas development decisions when no other data is available.

Geophysical and geological methods are used to maximize production after reservoir discovery as well. Reservoirs are analyzed using time lapse surveys (i.e. repeat applications of geophysical methods over time) to understand reservoir changes during production. The process of exploring for and exploiting subsurface hydrocarbon reservoirs is often costly and inefficient because operators have imperfect information from geophysical and geological characteristics about reservoir locations. Furthermore, a reservoir's characteristics may change as it is produced.

The impact of oil exploration methods on the environment may be reduced by using low-impact methods and/or by narrowing the scope of methods requiring an active source, including reflection seismic and electromagnetic surveying methods. Various geophysical data acquisition methods have a relatively low impact on field survey areas. Low-impact methods include gravity and magnetic surveys that maybe used to enrich or corroborate structural images and/or integrate with other geophysical data, such as reflection seismic data, to delineate hydrocarbon-bearing zones within promising formations and clarify ambiguities in lower quality data, e.g. where geological or near-surface conditions reduce the effectiveness of reflection seismic methods.

### SUMMARY

A method and system for processing synchronous array seismic data includes acquiring synchronous passive seismic data from a plurality of sensors to obtain synchronized array measurements. A reverse-time data propagation process is applied to the synchronized array measurements to obtain a plurality of dynamic particle parameters associated with subsurface locations. Imaging conditions are applied to the dynamic particle parameters to obtain image values associated with subsurface energy source locations.

### BRIEF DESCRIPTION OF THE DRAWINGS

FIG. 1 is a schematic illustration of a method according to an embodiment of the present disclosure for calculating images from the application of reverse propagation to synchronous signals to locate energy sources or reservoirs in the subsurface;

FIG. 2 illustrates schematically reverse time data propagation;

FIG. 3 illustrates a migrated image produced with acoustic extrapolators;

FIG. 4 illustrates two autocorrelation images to locate diffractions;

FIG. 5 illustrates a shot gather with modeling artifacts that manifest as diffractions;

FIG. 6 illustrates P and S modes within the total wave field u propagating from a source or diffractor that emits both type of waves;

FIG. 7 illustrates a) absolute particle velocity, b) P wave field and c) S wave field respectively after reverse propagating synthetic data from a vertical single force;

FIG. 8 illustrates six imaging condition options for a vertical single point force;

FIG. 9 illustrates imaging condition options for a horizontal single point force;

FIG. 10 illustrates imaging condition options for a 45° single point force;

FIG. 11 illustrates imaging condition options for a vertical double couple point force;

FIG. 12 illustrates a V/H particle velocity imaging condition;

FIG. 13 illustrates an example of a swarm of sources;

FIG. 14 is a flow chart of a data processing flow that includes reverse-time propagation processing of field data;

FIG. 15 illustrates a flow chart of a reverse-time propagation process to determine a time reverse imaging attribute;

FIG. 16 illustrates a flow chart according to an embodiment of the present disclosure for determining a signal to noise image that includes executing a TRI processing method with acquired seismic data as input;

FIG. 17 illustrates a flow chart for determining an image domain stack attribute;

FIG. 18 illustrates the division of a ‘real’ dataset with a non-signal noise dataset;

FIG. 19 illustrates a 2-D profile result of stacking imaging condition data output along the depth axis; and

FIG. 20 is diagrammatic representation of a machine in the form of a computer system within which a set of instructions, when executed may cause the machine to perform any one or more of the methods and processes described herein.

### DETAILED DESCRIPTION

Information to determine the location of hydrocarbon reservoirs may be extracted from naturally occurring seismic waves and vibrations measured at the earth's surface using passive seismic data acquisition methods. Seismic wave energy emanating from subsurface reservoirs, or otherwise altered by subsurface reservoirs, is detected by arrays of sensors and the energy back-propagated with reverse-time processing methods to locate the source of the energy disturbance. An imaging methodology for locating positions of subsurface reservoirs may be based on various time reversal processing algorithms of time series measurements of passive or active seismic data.

This disclosure teaches attributes extracted directly from energy focused or localized by the reverse time propagation. Additionally, this disclosure teaches that artificial or ambiguous focusing of reverse time images may be ameliorated or removed by accounting for the imaging artifacts velocity may introduce.

The methods disclosed here are equally applicable to seismic data acquired with so-called active or artificial sources or as part of a passive acquisition program. Passive seismic data acquisition methods rely on seismic energy from sources not directly associated with the data acquisition. In passive seismic monitoring there may be no actively controlled and triggered source. Examples of sources recorded that may be recorded with passive seismic acquisition are microseisms (e.g., rhythmically and persistently recurring low-energy earth tremors), microtremors and other ambient or localized seismic energy sources.

Microtremors are often attributed to the background energy normally present or occurring in the earth. Microtremor seismic waves may include sustained seismic signals within various or limited frequency ranges. Microtremor signals, like all seismic waves, contain information affecting spectral signature characteristics due to the media or environment that the seismic waves traverse as well as the source of the seismic energy. These naturally occurring, low amplitude and often relatively low frequency background seismic waves (sometimes termed noise or hum) of the earth may be generated from a variety of sources, some of which may be unknown or indeterminate.

Characteristics of microtremor seismic waves in the “infrasonic’ range may contain relevant information for direct detection of subsurface properties including the detection of fluid reservoirs. The term infrasonic may refer to sound waves below the frequencies of sound audible to humans, and nominally includes frequencies under 20 Hz.

Synchronous arrays of sensors are used to measure vertical and horizontal components of motion due to background seismic waves at multiple locations within a survey area. The sensors measure orthogonal components of motion simultaneously.

Local acquisition conditions within a geophysical survey may affect acquired data results. Acquisition conditions impacting acquired signals may change over time and may be diurnal. Other acquisition conditions are related to the near sensor environment. These conditions may be accounted for during data reduction.

The sensor equipment for measuring seismic waves may be any type of seismometer for measuring particle dynamics, such as particle displacements or derivatives of displacements. Seismometer equipment having a large dynamic range and enhanced sensitivity compared with other transducers, particularly in low frequency ranges, may provide optimum results (e.g., multicomponent earthquake seismometers or equipment with similar capabilities). A number of commercially available sensors utilizing different technologies may be used, e.g. a balanced force feed-back instrument or an electrochemical sensor. An instrument with high sensitivity at very low frequencies and good coupling with the earth enhances the efficacy of the method. The data measurements may be recorded as particle velocity values, particle acceleration values or particle pressure values.

Noise conditions representative of seismic waves that may have not traversed or been affected by subsurface reservoirs can negatively affect the recorded data. Techniques for removing unwanted noise and artifacts and artificial signals from the data, such as cultural and industrial noise, are important where ambient noise is relatively high compared with desired signal energy.

Time-reverse data propagation may be used to localize relatively weak seismic events or energy, for example if a reservoir acts as an energy source, an energy scatterer or otherwise significantly affects acoustic energy traversing the reservoir, thereby allowing the reservoir to be located. The seismograms measured at a synchronous array of sensor stations are reversed in time and used as boundary values for the reverse processing. A time-reversed seismic wave field is injected into the earth model at the sensor position and propagated through the model. Various imaging conditions may be applied to enhance the processing that localizes the events or energy. Time-reverse data processing is able to localize event or energy sources with extremely low S/N-ratios.

Field surveys have shown that hydrocarbon reservoirs may act as a source of low frequency seismic waves and these signals are sometimes termed “hydrocarbon microtremors.” The frequency ranges of microtremors have been reported between ˜1 Hz to 6 Hz or greater. A direct and efficient detection of hydrocarbon reservoirs is of central interest for the development of new oil or gas fields. If there is a steady source origin (or other wave field alteration) of low-frequency seismic waves within a reservoir, the location of the reservoir may be located using time reverse propagation combined with the application of one or more imaging conditions. Time reverse propagation may be associated with wave field decomposition. The output of this processing can be used to locate and differentiate stacked reservoirs.

Time reverse propagation of acquired seismic data, which may be in conjunction with modeling, using a grid of nodes is an effective tool to detect the locality of an origin of low-frequency seismic waves. As a non-limiting example for the purposes of illustration since microtremor characteristics are variable over time and space, as well as affected by subsurface structure and near surface conditions, microtremors may comprise low-frequency signals with a fundamental frequency of about 3 Hz and a range between 1.5 Hz and 4.5 Hz. Hydrocarbon affected seismic data that include microtremors may have differing values that are reservoir or case specific. Processed data images representing one or more time steps showing a dynamic particle motion value (e.g., displacement, velocity, acceleration or pressure) at every grid point may be produced during the reverse-time signal processing. Data for grid nodes or earth-model areas representing high or maximum particle velocity values may indicate the location of a specific source (or a location related to seismic energy source aberration) of the forward or field acquired data. The maximum dynamic particle parameters at model grid nodes obtained from the reverse-time data propagation may be used to delineate parameters associated with the subsurface reservoir location. Alternative imaging conditions useful with reverse time imaging of subsurface energy sources include combinations of particle dynamic behaviors and relationships, including phase and wave mode relationships.

There are many known methods for a reverse-time data process for seismic wave field imaging with Earth parameters from acquired seismic data. For example, finite-difference, ray-tracing and pseudo-spectral computations, in two- and three-dimensional space, are used for full or partial wave field simulations and imaging of seismic data. Reverse-time propagation algorithms may be based on finite-difference, ray-tracing or pseudo-spectral wave field extrapolators. Output from these reverse-time data processing routines may include amplitudes for displacement, velocity, acceleration or pressures values at every time step of the imaging.

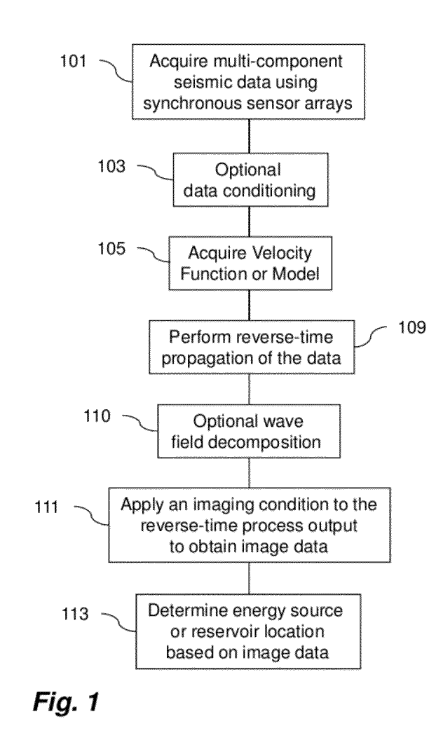

FIG. 1 illustrates a method according to a non-limiting embodiment of the present disclosure that includes acquiring seismic data to determine a subsurface location for hydrocarbons or other reservoir fluids. The embodiment, which may include one or more of the following (in any order), includes acquiring synchronous array seismic data having a plurality of components 101. The acquired data from each sensor station may be time stamped and include multiple data vectors. An example is passive seismic data, such as multicomponent seismometry data from long period sensors, although passive acquisition (not using artificial sources as this is understood in the art) is not a requirement. The multiple data vectors may each be associated with an orthogonal direction of movement. The vector data may be arbitrarily mapped or assigned to any coordinate reference system, for example designated east, north and depth (e.g., respectively, Ve, Vn and Vz) or designated Vₓ, V_{y} and V_{z} according to any desired convention and is amenable to any coordinate system.

The data may be optionally conditioned or cleaned as necessary 103 to account for unwanted noise or signal interference. For example various processing steps such as offset removal, detrending the signal and band pass or other targeted frequency filtering or any other seismic data processing/conditioning methods as known by practitioners in the seismic arts. The vector data may be divided into selected time windows for processing. The length of time windows for analysis may be chosen to accommodate processing or operational concerns.

Additionally, signal analysis, filtering, and suppressing unwanted signal artifacts may be carried out efficiently using transforms applied to the acquired data signals. The data may be resampled to facilitate more efficient processing. If a preferred or known range of frequencies for which a hydrocarbon signature is known or expected, an optional frequency filter (e.g., zero phase, Fourier of other wavelet type) may be applied to condition the data for processing. Examples of basis functions for filtering or other processing operations include without limitation the classic Fourier transform or one of the many Continuous Wavelet Transforms (CWT) or Discrete Wavelet Transforms. Examples of other transforms include Haar transforms, Haademard transforms and Wavelet Transforms. The Morlet wavelet is an example of a wavelet transform that often may be beneficially applied to seismic data. Wavelet transforms have the attractive property that the corresponding expansion may be differentiable term by term when the seismic trace is smooth.

Imaging using field-acquired passive seismic data, or any seismic data, to determine the location of subsurface reservoirs includes using the acquired time-series data as ‘sources’ in reverse-time wave propagation, which requires velocity information 105. This velocity information may be a known function of position or explicitly defined with a velocity model. A reverse-time propagation of the data 109 is performed by injecting the time-reversed wave-field at the recording stations. The output of the reverse-time processing includes one or more measures of the dynamic particle motion of sources associated with subsurface positions (which may be nodes of mathematical descriptions (i.e., models) of the earth).

Optionally, wave equation decomposition 110 may be applied to the data undergoing reverse time propagation to facilitate various imaging conditions to apply to the data. An imaging condition is applied to the dynamic particle motion output during or after the reverse-time processing 111 to obtain image data. The final output of the reverse-time processing depends on the imaging condition or conditions used. The imaging condition is applied 113 to determine the location of the energy source, or the reservoir location.

TRM means propagating a seismic wave field through a velocity model after reversing the time axis. Various propagation methods may be used, for example both one-way acoustic and time-domain finite difference elastic propagation schemes. Data are injected into the model domain as sources at recording stations. This disclosure is focused on the addition of physically meaningful automatic imaging conditions to time reverse propagation methods. The complete imaging method is the chain of reverse propagating the recorded wave field, spatial processing to separate P and S energy for the elastic case, followed by evaluating an imaging condition to collapse the time axis which produces an image in physical space. This chain of operations is time-reverse imaging (TRI).

The use of fully elastic time-domain wave-equation propagators when multicomponent data are available provides a more complete solution to the underlying physics of propagation since it removes the need for many assumptions and preprocessing. Processing steps, such as wave-field decomposition, are instead performed after propagation in the image domain which enjoys more regular sampling and a complete depth axis. Additionally, anisotropy can readily be included in the methods.

With only a single wave field available for TRM, correlation based imaging conditions as used in reflection migration are not obviously implemented. For simple arrivals in the data, visual inspection of the propagation axis can identify source focusing. This is difficult or not possible in 3D applications and for low SNR data or events with complicated wavelets.

With a single wave field, autocorrelations may be implemented at every model location (x,y,z) after propagation. The method uses cross-correlation imaging conditions between P and S-wave potential wave fields. While several specific imaging conditions are disclosed, the use of “image-domain processing,” whereby multiple imaging conditions are evaluated together, each designed to image various physical mechanisms or wave-field components. This approach produces a suite of images to be compared and contrasted to interpret finer details about the source mechanism beyond just its location in space.

Herein is disclosed the kinematics of reverse propagation and the use of autocorrelation to locate subsurface sources. Additionally the example application of an acoustic algorithm on a synthetic marine data set containing the added complication that targeted diffraction events are embedded within a reflection wave field. Further, several embodiments encompass wavefield decomposition methods that facilitate vector imaging conditions. Next, there is a demonstration of the impulse response of the full elastic imaging algorithm with various simple source mechanisms including oriented single point forces and the double couple in a homogeneous medium. Finally, a complex synthetic example including a swarm of sources within a realistic Earth model is disclosed to show the robustness of the method.

Various embodiments can be implemented for arbitrary acquisition geometries, though the examples presented here are developed with surface acquisition. The main advantages of this imaging-based methodology may be realized for surface arrays with large numbers of stations. Therefore, while station borehole geometries are not discussed herein, extending the methods to boreholes is straightforward. Also, while the embodiments described are two-dimensional, it will be appreciated that the three-dimensional extension is included in the embodiments disclosed herein.

Time-reverse modeling (TRM) was developed for locating sources emanating from within a fairly well characterized domain. The method is suited for locating earthquakes, microseisms, or tremor sources.

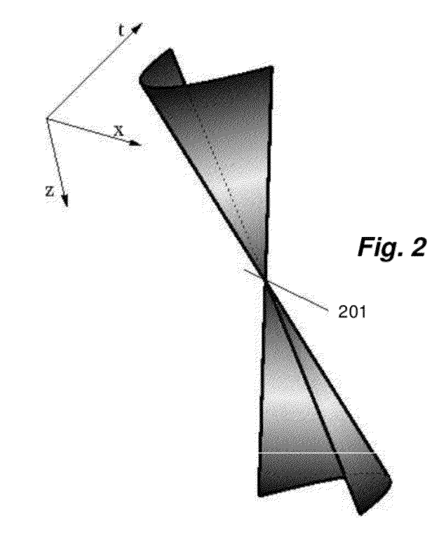

FIG. 2 shows the simple kinematic surface of an energy source in a homogeneous x, z, t-space. The extrapolation direction is defined as z, but of course could be any model domain vector. Familiar hyperbolic events are extracted from an x, t-plane. Reverse propagating recorded data, d(x, z=0, t), into the image domain fills the z axis, and a recorded event is collapsed to the intersection of the two cones. Without knowledge of where to insert sink locations however, focuses are subsequently expanded with further extrapolation steps.

After creating the depth axis from the time data by propagation, the geophysicist must decide how to use the larger data volume. This method locates the source in physical space when onset time (a typical source parameter in event triangulation methods) is not available. However, coarse resolution of the time parameter is available by the individual time window(s) processed. FIG. 2 schematically shows that by back propagating the data, the energy at the source location 201 is a maximum at the location of constructive interference from the energy distributed across the sensors in the array. This summation is the reason that the SNR of the image is improved compared to the data SNR as the energy from individual stations is focused in the model space. Kinematically, focus occurs when all the planar segments of a hyperbola with opposite signed, equal ray parameters, meet. For surface arrays, this highlights how important aperture is, and that the central, flat hyperbola top does not contain complete information.

Imaging conditions are generally measures of the multi-dimensional space, usually removing some of the dimensionality (time axis), and are designed to specifically capture information relevant to the problem being analysed. Finding the location in space of maximum energy immediately suggests use of an L^{p} norm across the time axis, t, at every spatial location, x,∥x∥ₚ=(Σₜ|xₜ|^{p})^{1/p}. The L^{∞} norm returns the maximum of a vector as disclosed in US Application Serial No. 20080175101, which is incorporated here by reference for all purposes. Other methods use the sum over all time. The zero lag of the autocorrelation of an arbitrary vector over time, α(0)=Σₜc(t)² can be viewed in two ways as a norm. Either, it is an incomplete L² norm that can be completed by taking the square root, or as the L^{∞} norm of the autocorrelation. An imaging condition embodiment disclosed herein is to locate sources in the simple case of a scalar potential wave field: The zero lag of the time autocorrelation evaluated at every space location for image i and data d,

i(x,z)=Σₜd(x,z,t)² (1)

The imaging condition may be interpreted as the infinity norm of the autocorrelation to highlight the collapse of complicated waveforms. The maximum amplitude measure captures only the peak amplitude component of any wavelet. In the case of multiple wavelets, the image is constructed with only the single strongest event in the series. Conversely, correlation captures much more of the energy from complicated or long wavelets, and continues to add contributions from all events contained in the vector. The squared particle-velocity amplitudes returned from correlation have units directly proportional (by mass) to energy in Joules.

Diffractions within active seismic data are examples of one-way wave fields embedded within two-way wave fields. Despite the presence of the reflections in the data, diffractors can be located with the time-reverse modeling imaging methodology by extracting focus locations in the back-propagated wave field by autocorrelation of the data wave field.

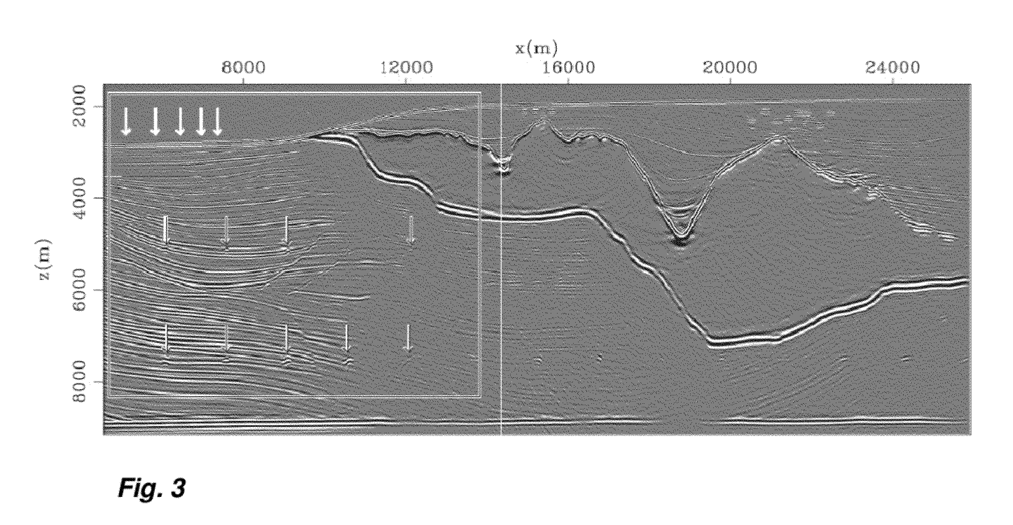

FIG. 3 is a migrated image produced with acoustic extrapolators applied to the Sigsbee2b synthetic data set. The data are a publicly available marine towed array (hydrophone) active seismic synthetic generated to test processing algorithms. Arrows at the sea floor point to discontinuities in the model due to implementing dipping reflectors with a Cartesian finite-difference grid. The model includes strings of diffractors across two depth levels (indicated by arrows at z(m)=5200, 7500 m) which may be located in space.

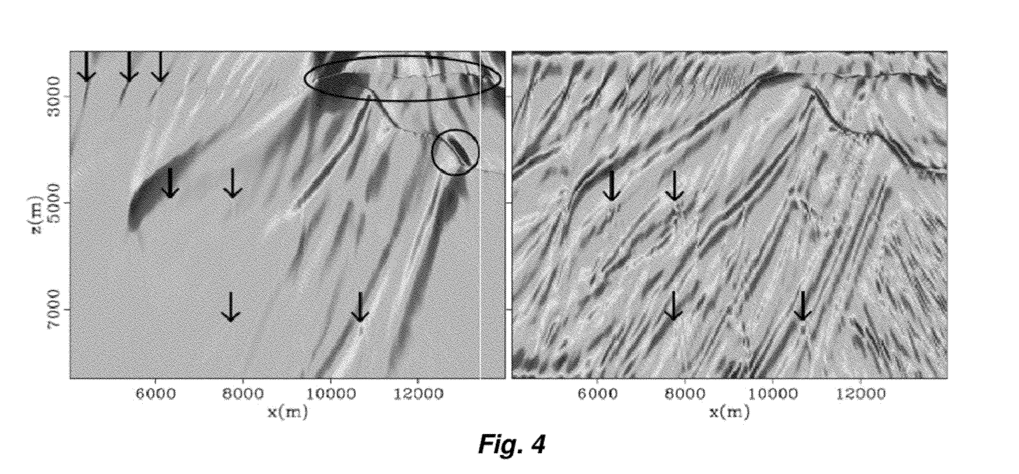

FIG. 4 illustrates two autocorrelation images (Equ. 1) to locate diffractions. Left image is post processed with AGC. Right image also includes low-cut filtering. Images are the sedimentary section (first 40 shots) of the Sigsbee2b data in FIG. 3. Sigmoidal focus shapes on the sea-bottom diffractors are due to off-end acquisition. Deep diffractors are indicated with arrows.

The results in FIG. 4 are calculated with the imaging condition in Equ. 1. They are two versions of the diffractor image produced with the first 40 shots of the data and different post-processing algorithms. This amount of data illuminates approximately the left half of FIG. 4. The first panel is the result of AGC, while the second includes a low-cut filter in the depth direction. Arrows indicate the first three of a series of sigmoidal focuses across the water bottom, and a few focuses of the diffractors (rows at z=5200, 7500 m). The circles highlight strong, very dense energy accumulations along the steep salt flanks.

The strong focus patterns in FIG. 4 at the seafloor are positioned exactly at the location of the arrows in FIG. 3 showing the sea-floor steps that approximate dip in the gridded model. These focuses show the sigmoidal impulse response of the imaging procedure with off-end streamer acquisition. The deep diffractors are not as well imaged above the background energy due to the unfocusing energy from the very strong shallow diffractors. The low-cut filtering in the second panel highlights the diffractors a little better at the price of enhancing the energy emanating from the salt lensing above.

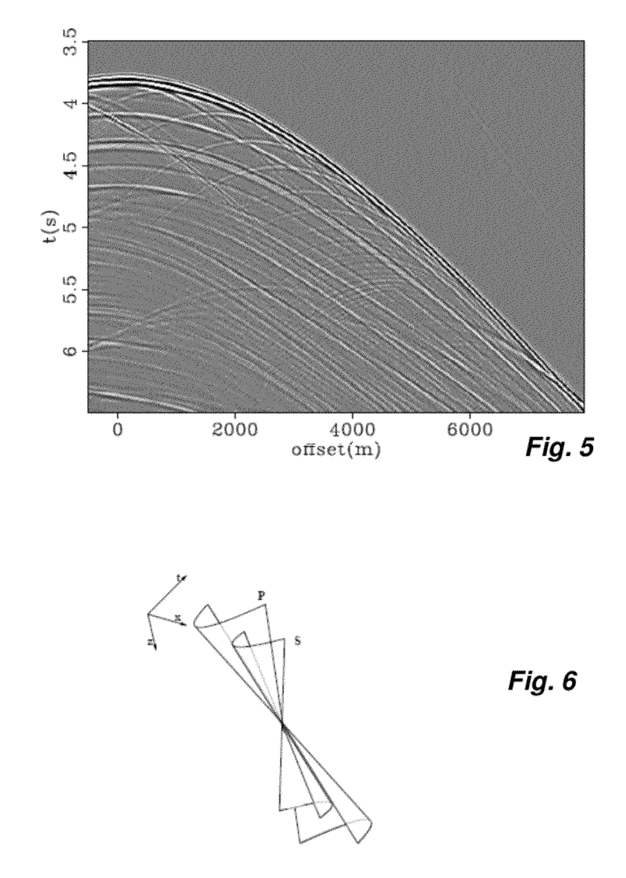

Although the deep diffractors were the target diffractors for imaging, many more diffractors were successfully imaged in the shallow section of the data that are actually modeling artifacts in the data. FIG. 5 shows the first few seconds of a representative shot gather after the sea bottom reflection showing modeling artifacts that manifest as a large number of diffractions in the data. Nearly every reflection, and especially the strong sea floor and salt arrivals, are highly contaminated by diffractions. All of these (unrealistic) diffractors put energy into the autocorrelation of the data that make interpreting the deep section more difficult. The steep salt flanks, also modeled with many step functions, are also imaged clearly (circled in FIG. 4), but add unrealistic difficulty to imaging the deep diffractors.

Embodiments disclosed herein include vector processing in the image domain. Historically, acquisition plane processing has been relied on for wave-field decomposition for most multicomponent data processing. Distinct scalar potential wave fields are then independently propagated into the image domain. Coupling between the shear and compressional wave fields can be re-introduced in the imaging condition via a correlation of the two wave fields. This is effectively a single-scattering representation of the complete wave equation.

The full elastic solution to the wave equation can be implemented rather than the far-field acoustic approximations routinely utilized while incurring a substantial increase in computational burden. So doing removes the approximations in pre-processing of the raw data to separate P and S energy within the records. In the case of low signal to noise ratio one-way wave fields, the required information to perform the pre-processing correctly may even not be available. FIG. 6 illustrates P and S modes within the total wave field u propagating from a source or diffractor that emits both type of waves. FIG. 6 updates the kinematic surface shown in FIG. 2 with the inclusion of P and S energy that are only collocated at the location of the source/scatter/mode converter. The relations below are used to extract single propagation modes from the total wave field resulting in two scalar potential wave fields derived from the multicomponent vector wave field at every step along the propagation time axis. Performing the decomposition in the model domain after extrapolation ensures a regular and complete domain that does not require approximations for the vertical derivative. Fortunately, only two simple vector identities are needed to separate P and S energy for isotropic media since the displacement wave field, u(x, t), can be described as the sum of potential wave fields.

The wave-field may be decomposed into scalar potentials for a source focusing algorithm before applying an imaging condition. Capitalizing on the facts that the curl of the irrotational potential is zero and the divergence of the solenoidal potential is zero, the compressional, Eₚ, and shear, Eₛ, kinetic energy densities are

Eₚ=P²=(λ+2μ)(∇·u)², and Eₛ=S²=μ(−∇×u)² (2)

where the Lame coefficients λ and μ scale the amplitude of the results. The wave fields P and S have preserved sign information (zero mean) that captures the relative amplitudes within the two propagation modes, whereas the quantities E are strictly positive due to squaring (the inner product for S). In 2D, the vector S has only one non-zero entry which is physically the Sₚ-wave. For 3D, we suggest combining the 2nd and 3rd components may be combined as an Sₕ potential. In the near field, defined by the distance of propagation required to fully separate P and S wavelets, the source simultaneously contains both P and S-like components and is strictly neither P nor S in nature. However, the source energy still maps through both the divergence and curl operators according to Aki and Richards.

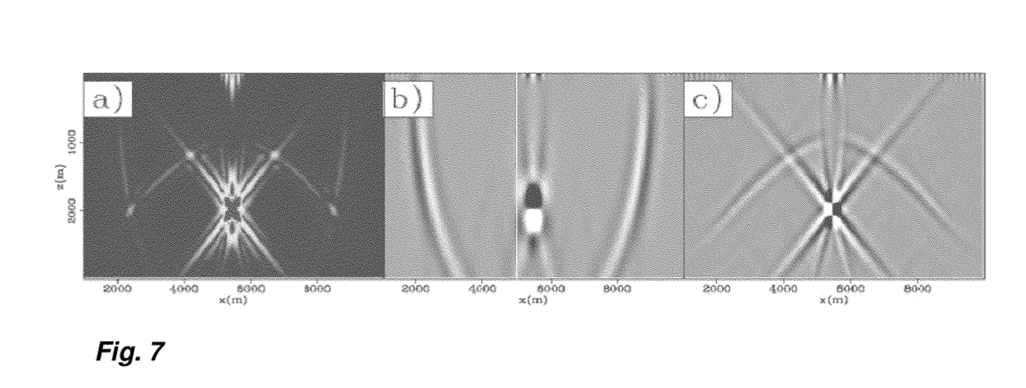

FIG. 7 illustrates absolute particle velocity, P and S wave field respectively after reverse propagating synthetic data from a vertical single force to the onset of time. The radiation pattern of the source is imaged at the correct depth.

FIG. 7 illustrates the collapse of energy from a source at depth recorded at the surface via reverse propagation of the elastic wave field in a homogeneous medium. The panels are all extracted from the extrapolation time axis at the initiation time of a vertical single force point source in an elastic medium. This means no automatic imaging condition has been applied, but we have exploited knowing the onset time of the source in the synthetic. The goal of an automatic imaging condition is to extract an image similar to these without needing to know the time of occurrence.

FIG. 7a is the absolute particle velocity. Panels b and c are the P and S-wave potentials by Equ. (2). The source is located at the maximum amplitude of panel a and at the zero crossings in the center of panels b and c. Longer wavelengths are seen on the P image due to faster propagation velocity. The extra events on panel b are the limited aperture artifacts. The linear events on panel c are nonphysical artifacts associated with injecting the data as sources. The hyperbola on panel c is the P-S conversion from the free surface. Panels b and c are already indicative that our reverse propagation algorithm is actually sensitive to the radiation pattern of the source rather than simply the source location shown as a maximum in Panel a. The vertical single point source is located at the zero crossings, and the radiation pattern of the mechanism is maintained in the images.

The use of elastic propagators and mode separation in the image domain has important benefits for source location. In an isotropic homogeneous Earth, all hyperbolas are similar such that any velocity-depth pair can share a common data representation: A shallow P event has the same moveout as a deep S event. Since reverse propagation simply collapses moveout to a subsurface point, this means that S events will focus with P-wave velocities (and vice verse), but at the incorrect depth. Also, ray-based summation type approaches will have difficulties with sign reversals associated with the maximums and nodal planes of non-explosive sources unless geometries and radiation patterns can be estimated a priori.

Other embodiments disclosed herein encompass elastic time-reverse modeling. Decomposing the vector wave field into physically meaningful scalars allows the development of several correlational imaging conditions as opposed to the autocorrelation available in the acoustic case presented with Sigsbee data. We follow the correlation type combination of the wave field components P and S to image the mode-converted reflections in active seismic data. The PS correlation body-wave image is

Iₚₛ(x,z)=ΣₜP(x,z,t)S(x,z,t) (3)

This case is a one-way, single wave field problem so that both quantities are derived from the same up-going wave field. Also the autocorrelations can be performed as well, analogous to Equ. (1). Further, the correlation between the energy density functions, EₚEₛ from Equ. (2), will also have some advantages discussed later.

The P-S elastic imaging condition for locating subsurface sources exploits the fact that the P and S-waves produced by an oriented source propagate at different speeds. The model domain location at which these wave types are both at time zero after reverse propagation is the location of the source. This location is identified by cross correlating the two wave fields, though for the various source mechanisms shown below, nodal planes result in the source location is indicated by a zero-crossing rather than a maximum in the image.

We present images from synthetic point sources (double couple and vertical, 45°, and horizontal single forces) to show the impulse response of the various mechanisms through the time reverse imaging procedure. It is important to remember that the impulse response of the experiment is greatly affected by the acquisition geometry as well as source mechanism. As an example, a homogeneous model is used, characterised by compressional velocity Vₚ=3000 m/s, Poisson's ratio ν=0.3, density ρ=2000 kg/m3, sampled at 10 m in all directions. A Ricker wavelet time function is used with dominant frequency 4 Hz. The low frequency content is selected specifically to investigate the ability of the method to image tremor signals and highlights the added ability of the algorithm to work near the near field of the source by not simplifying the form of the propagator. Data are simulated with mildly irregular receiver spacing≈900 m.

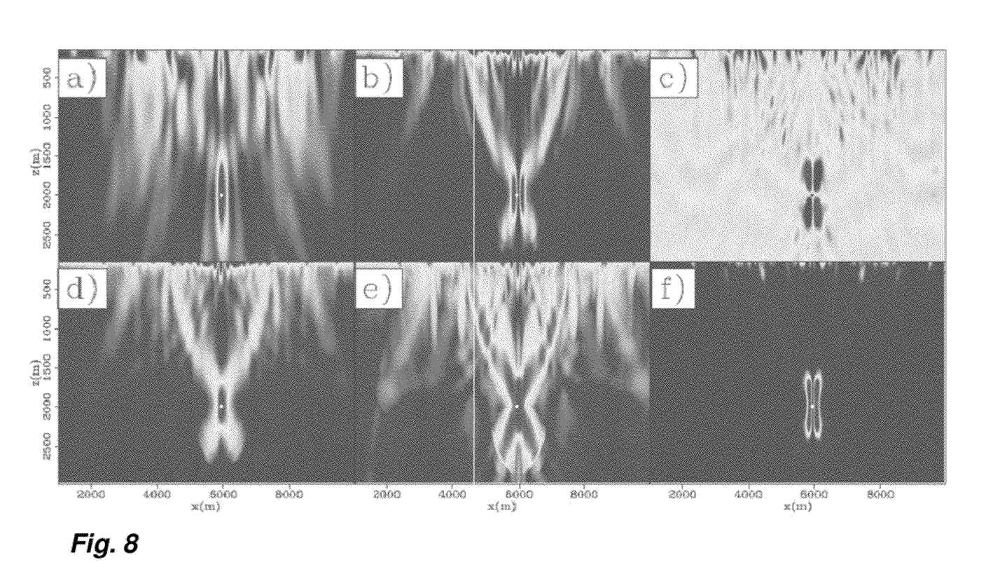

FIG. 8 illustrates six imaging condition options for a vertical single point force. Panels a, b and c are PP(0), SS(0), and PS(0) respectively. Panel d is the autocorrelation of the absolute value of particle motion. Panel e is the maximum over all time. Panel f illustrates EₚEₛ(0). Dots (white) illustrate point source location.

As an example of using a vertical single point force, the top row of FIG. 8 shows the zero lag of the autocorrelations of P and S energy (panels a and b) and their cross correlation (panel c) after reverse propagating the forward modeled data. While the autocorrelations are strictly positive, the correlation of the P and S wave fields has zero mean. The source location in panel c is at the location of a zero crossing, thereby having an amplitude identical (or similar) to most of the rest of the domain. The anti-symmetric clover-leaf pattern surrounding the source identifies its location. This indicates that the TRM algorithm is really imaging the radiation pattern of the emitted energy, rather than the source location specifically. Thus, different source mechanisms should have different impulse responses associated with the various imaging conditions available.

This top row of images are the imaging results (including field sampling geometry) that we construct by developing automatic imaging conditions to extract the information in the time slices shown in FIG. 7. Those time slices can also be viewed as the inputs to the correlations performed in FIG. 8 to understand the various nodes and maximums in the images.

Note also that for limited aperture arrays, the horizontal resolution is much better than the vertical. Horizontal resolution is dictated most strongly by array aperture. Vertical resolution is mostly a function of the frequency content of the source. However, resolution can be considered in terms of both accuracy and precision. A single maximum (or zero crossing) location can be selected from the images that will be very precise. However, the accuracy should be considered in terms of standard quarter wavelength considerations. The correctness of the velocity model is also very important of course. The asymmetry revealed in the impulse response of the mode cross-correlation imaging condition in FIG. 8c suggests simple post-processing to identify the source position with an energy anomaly instead of the multi-dimensional zero crossing seen in the image. A ±90° phase rotation in both directions of the image in panel c locates the source with a maximum. This is easily implemented with a 2D spatial integral or derivative of the result, with the loss of the radiation pattern information.

FIG. 8d is the zero lag of the autocorrelation of the absolute particle velocity over all propagation time: abs²(0). This is approximately the square of panel e, vₘₐₓ, which is the maximum absolute particle velocity over all time. For single point forces, the relationship between panels d and e is exactly the square, but for multiple sources contained in a single wave field, the relationship is complicated by cross-talk effects. Panel f is the crosscorrelation of the energy density functions E_{P}E_{S}. As before, panel f is approximately the square of panel c. However, in the case of complicated super-posed wave fields, summing the individual contributions of many sources with the squared correlation can perform better by avoiding potential destructive interference of neighboring impulse responses seen in panel c.

Next, the same six imaging conditions are illustrated using a horizontal single point force. For unknown source functions, computing all possible images will provide polarization information about the source function as well as location. Given a sparse acquisition and velocity model errors, it is important to model these impulse response images with real acquisition parameters for several potential source mechanisms. As such, results are provided herein using the same suite of imaging conditions and continued from above by varying the nature of the source function.

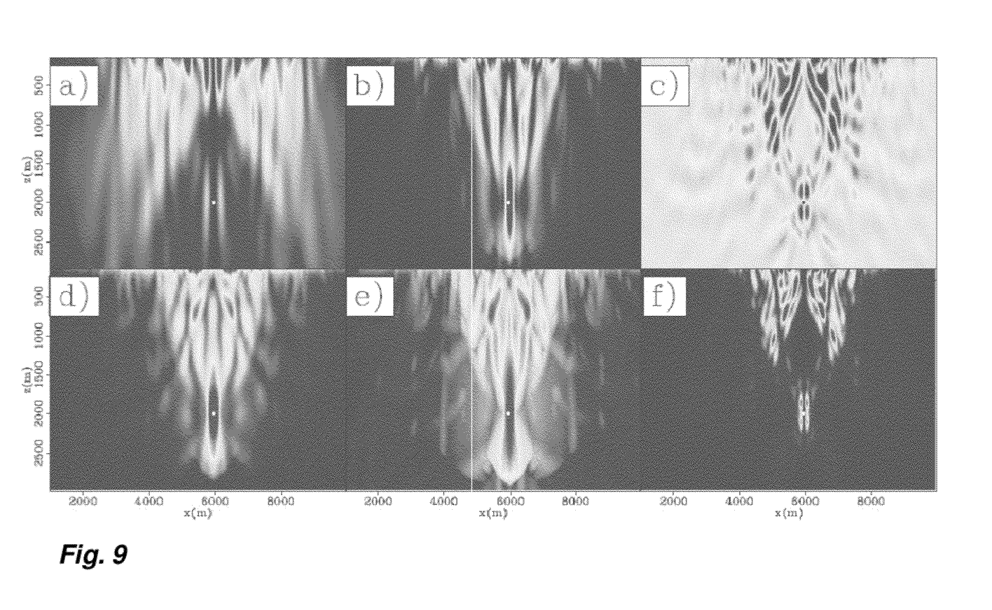

For forward modeled data due to a horizontally oriented single point force, FIG. 9 shares the same illustration layout structure as FIG. 8. FIG. 9 illustrates imaging condition options for a horizontal single point force. Panels a, b and c are respectively PP(0), SS(0) and PS(0) on the top row, and on the bottom row, autocorrelation of absolute particle velocity, abs²(0), maximum absolute particle velocity, vₘₐₓ, and the correlation of the energy density fields E_{P}E_{S}(0). Due to the opposite orientation of the source functions and their concomitant radiation patterns, the focusing characteristics of panels a and b in FIG. 9 have switched from the response in FIG. 8. The P-wave autocorrelation focus amplitude in panel a is not as high as the S-wave focus in FIG. 8b due to the fact that the amplitudes scale with slowness, and the surface array is centered over the P-wave node. Panels c and f have tighter focusing due to the higher wavenumber content of the S-waves, as noticed in FIG. 7, which make up the predominance of the energy content for this combination of acquisition geometry and source mechanism.

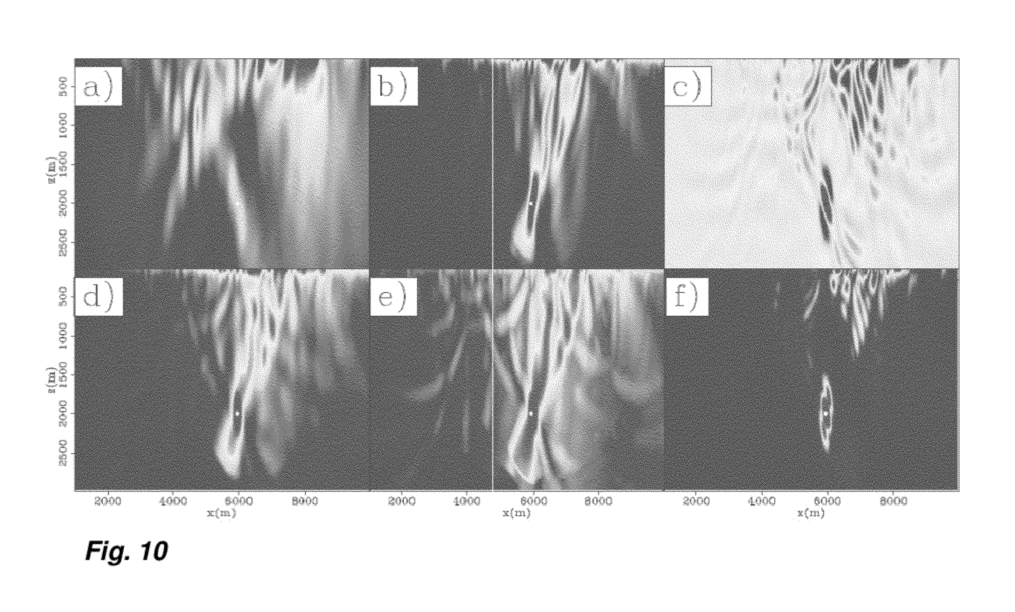

FIG. 10 illustrates imaging condition options for a 45° single point force. Panels a, b and c are respectively PP(0), SS(0) and PS(0) on the top row, and on the bottom row, autocorrelation of absolute particle velocity, abs²(0), maximum absolute particle velocity, vₘₐₓ, and the correlation of the energy density fields E_{P}E_{S}(0). Dots indicate source location.

The PP(0) image in FIG. 10a shows only weak focusing compared to the alternative imaging conditions in the rest of the images. The maximum direction of P-wave transmission, up and to the left, sends energy predominantly to only half of the array as energy diminishes toward increasing x and amplitudes diminish toward the P-wave node of source function. Contrasting observations can be made in the remaining images that contain more shallow artifacts on the right sides of the results due to the larger energy content of the S-wave maximum traveling in that direction.

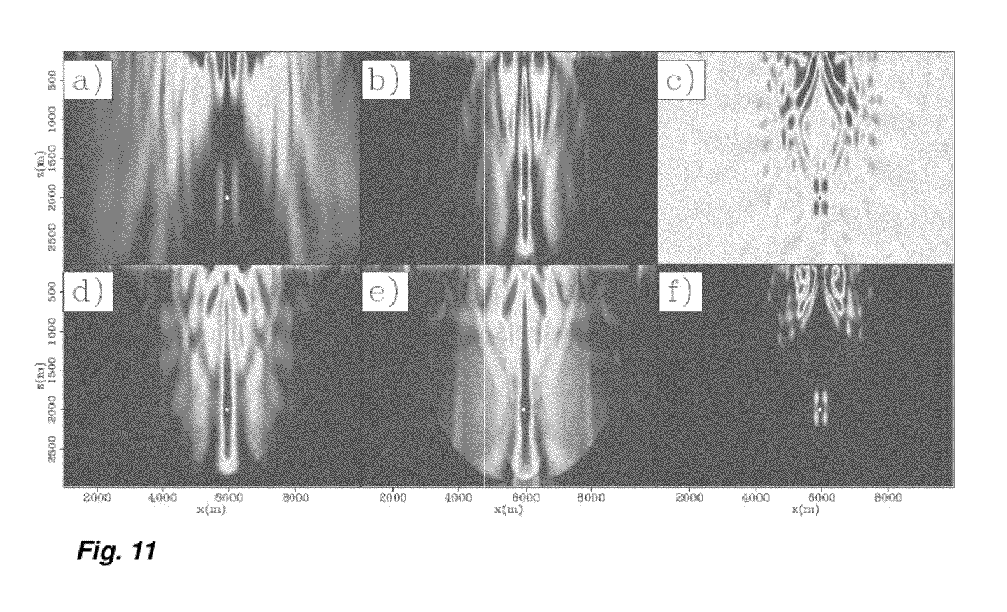

FIG. 11 illustrates imaging condition options for a vertical double couple point force. Panels a, b and c are respectively PP(0), SS(0) and PS(0) on the top row, and on the bottom row, autocorrelation of absolute particle velocity, abs²(0), maximum absolute particle velocity, vₘₐₓ, and the correlation of the energy density fields E_{P}E_{S}(0). Dots indicate source location.

FIG. 11 shows the impulse response of the various imaging conditions considered (PP, SS, PS, abs², vₘₐₓ, E_{P}E_{S} respectively) for a double couple point force forward modeled by seeding the xy components of the stress tensor with the source wavelet. For this mechanism, the P-wave node is vertical and the S-wave event is maximum toward the surface. Without receivers completely surrounding the domain, this source mechanism images almost the same as the horizontal point force, FIG. 9, because the radiation patterns only contrast for measurements completely surrounding the source. The minor decrease in amplitude in the center of the focus in panel b is the only real difference to the horizontal single force. The situation would be similar with respect to a vertical single force if the double couple is rotated 90°.

Another condition to consider is particle velocity ellipticity. Various imaging conditions with physical significance associated with an assumed source mechanism can be designed to test hypotheses about the character of an unknown source such as specific polarization concepts. Within the model domain, the ratio of vertical and horizontal particle motion can be indicative of surface versus body wave modes. Therefore, one can also construct an image by the autocorrelation of the vertical divided by the horizontal (or inverse) component after propagation.

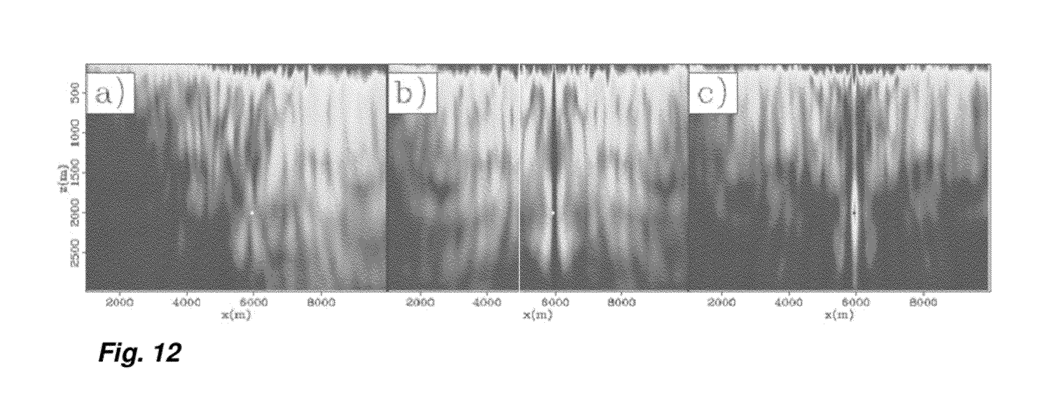

FIG. 12 illustrates V/H particle velocity imaging condition for 45°, horizontal and vertically oriented single point forces. Dots indicate point source location. FIG. 12 illustrates three images of the autocorrelation of the wave field calculated during time-reverse modeling by extracting the ratio of the vertical to horizontal particle velocity: V/H. The first panel modeled a single point force oriented 45° to the surface. The center panel is the result from a horizontal single point force, and the right panel is due to a vertical point force. The first two panels do not show significant focusing over the background energy, while the vertical source is well imaged. The selection of this particular form is useful to test specific polarization concepts.

The maximum particle velocity and V/H imaging conditions can be interpreted within the framework of a simple polarization analysis. The largest eigenvalue is close to the concept underlying the vₘₐₓ imaging condition, and V/H is close to the ratio of eigenvalues, or rectilinearity.

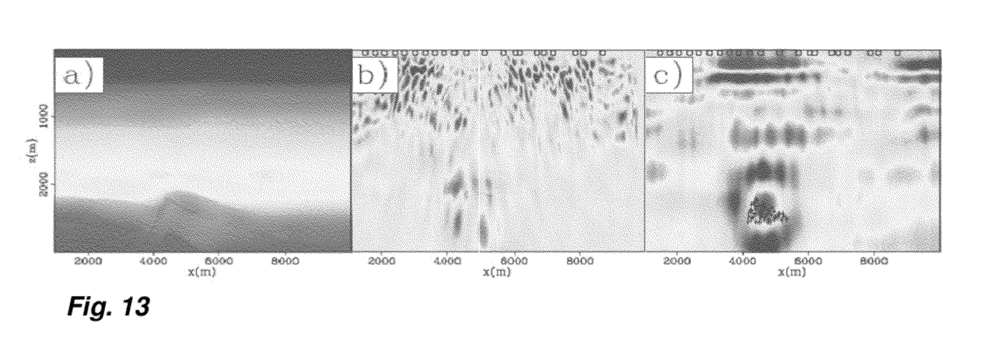

FIG. 13 illustrates an example of a swarm of sources. FIG. 13a shows a real P-wave velocity model used to forward model a source location experiment. Constant Vₚ/Vₛ ratio and density were used for this exercise. The receiver stations are indicated by the circles at the top of panels b and c. The modeled data were produced with a swarm of 100 randomly triggered, in space, vertical single point forces indicated by the asterisks in panel c. Ricker wavelet time functions with central frequency 4.5 Hz were randomly triggered up to 10 times along the time axis at each location. The goal was to generate time signals with so much cross-talk as to be uninterpretable and have the appearance of randomness (which was achieved) to simulate a low frequency tremorlike signal by the superposition of simple mechanisms.

Panel b is the TRM image with correlation imaging condition of the P and S wave fields as in Equ. (3). The complexities of irregular acquisition geometry, complex subsurface velocity, and simultaneously imaging many sources introduce cross-talk artifacts in panel b, which are mostly confined to the upper 1200 m of the image. However, there is a feature at approximately 2300 m depth resembling the antisymmetric cloverleaf seen in the impulse response image in FIG. 8c. Even though more than 500 individual sources were processed simultaneously in a complex summation wave field, identifiable features in the image can be related to the impulse response tests shown above.

The actual location of the center of mass of the source swarm is at a fairly large area of a zero crossing which is not very different from the values in much of the domain. Instead, the locations are indicated by the radiation pattern of energy surrounding the source location. As suggested above while discussing FIG. 8c, a 90° phase rotation in x and z-directions will transform the antisymmetric clover into a dot. Integration and differentiation both supply the desired post-processing, and can simply be implemented in the Fourier domain with division or multiplication (respectively) by (−kₓk_{z}). For complex and noisy data, the integration is more stable at the cost of a less compact point of energy in space. Panel c is the integration of panel b with the source locations overlain. While the 2D integral of panel b presented in panel c nicely images the center of mass of the swarm of source events, the horizontal stripes above the sources introduced during the process could be misinterpreted.

Nonlimiting embodiments disclosed herein illustrate using the chain of elastic propagation, wave-field decomposition, and correlation imaging to locate subsurface sources and diffractions. By defining migration as a process of extrapolation followed by an imaging condition, and even use the same code-base, these techniques provide a set of migration and imaging algorithms addressing different kinematic problems than the reflection seismic community has previously addressed. In general, migration algorithms can be viewed as a physically tuned form of stack, which is possibly the single most powerful concept in data processing. Focusing energy at locations in the model domain via propagation and then applying an appropriate imaging condition effectively sums the contribution from all receivers to the scattering event being imaged.

Viewed in this light, migration algorithms are especially beneficial when the data domain suffers from poor signal to noise ratio. Weak signal may be present and significant, but not observable in the data until the cohesive contribution from all receivers is aligned and summed. A second issue that can lead to phenomena being difficult to observe in the data domain is the convolution of a simple process with a complicated source function, especially as the time duration of the function increases toward a quasi-stationary tremor-like signal. Under such circumstances, correlation based imaging conditions offer substantial benefit.

A method to image events that are not detectable in the data domain can be especially powerful for event location in micro-seismic monitoring. The power-law magnitude distribution of seismic events stipulates that for every increment down in magnitude we should expect about 10 times as many smaller events. This leads to the understandable desire for greater hardware sensitivity, and installation as close as possible to the region of interest in order to collect ever more complete data sets. Regardless of how successful we are at engineering solutions for data acquisition, there should always be many more undetectable events that we can try to find through the power of a physically tuned (wave-equation) stacking algorithm such as the TRM imaging algorithm we describe here.

It is logical to use fully elastic propagators for a migration or focusing algorithm when recording the full wave field in any geophysical experiment. Especially in the case of event location, the TRM algorithm benefits from elastic propagators because it may be impossible to adequately characterize the source as required for wave-field decomposition at the acquisition plane. This is particularly important for sources that are not transient in nature or compact in time. We advocate using a time-domain (finite-difference) solution to the elastic wave equation. Multicomponent time-reversed data are source functions for the outer time loop. Wave-field decomposition and correlations are performed at each time step. Because only the zero lag of the correlations are required, the image is simply calculated by accumulating the product of wave fields at every extrapolation step. We advocate implementing as many physically meaningful imaging conditions as can be imagined, rather than claiming one is uniformly better than others. Additional computation time associated with the imaging conditions is trivial compared to the extrapolation computation. Combined interpretation of several images leads to a more complete understanding of the source being imaged.

In this application the critical time differences used for imaging can be extracted from the time delay between P and S-wave travel paths. Also, autocorrelations of the two wave modes is a maximum at the source location. For those familiar with the concept, source location performed in this way is almost identical to the preparation of illumination images calculated to normalise shot-profile migration results. The methodology is sufficiently robust to tolerate irregular acquisition geometry and multiple sources in the wave field. Accurate interval velocity models are an important requirement for the method.

Focusing subsurface sources by extrapolating time-reversed data is dependent on source mechanism, acquisition geometry, and the imaging condition used. An important feature of this method is the correct handling of P- and S-wave arrivals without any pre-processing or assumptions. For the horizontal single force and the double couple, most of the energy on the records is likely to be from S-wave arrivals, while the P arrival may not be detectable. If this energy is imaged with acoustic far-field extrapolators and P-wave velocity, it will focus at the wrong location. Thus, it is important to collect multicomponent data and use the entire wave field in the processing algorithm. When recording only at the surface, the images from a horizontal single force vs. horizontal double couple (FIG. 9 and FIG. 11) may be difficult to distinguish in field data. Under the power-law magnitude distribution of fracture events, there is likely a very large amount of micro-seismic energy contained in monitoring data that is below the signal to noise threshold for detection in the data domain.

Resolving individual events with precise locations is possible with this imaging technique if short time windows of data are processed containing only single arrivals. However, given the expense of imaging in this manner, and its applicability to complicated wave fields that are the superposition of many arrivals, we believe the principle benefit of the technique to the subsurface source location problem is the location of the center of mass of large distributions of small events.

Uncertainty in interpreting images from field data can be significant for wave fields with low signal to noise ratio or those containing a superposition of many overlapping events. In these cases, it is important to forward model point source tests at various locations in the local velocity model to aid in identifying artifacts of the acquisition. Propagating purely random data through the model will also help to identify false focusing due to lensing or wave guides in the velocity model.

While data may be acquired with multi-component earthquake seismometer equipment with large dynamic range and enhanced sensitivity, many different types of sensor instruments can be used with different underlying technologies and varying sensitivities. Sensor positioning during recording may vary, e.g. sensors may be positioned on the ground, below the surface or in a borehole. The sensor may be positioned on a tripod or rock-pad. Sensors may be enclosed in a protective housing for ocean bottom placement. Wherever sensors are positioned, good coupling results in better data. Recording time may vary, e.g. from minutes to hours or days. In general terms, longer-term measurements may be helpful in areas where there is high ambient noise and provide extended periods of data with fewer noise problems.

The layout of a data survey may be varied, e.g. measurement locations may be close together or spaced widely apart and different locations may be occupied for acquiring measurements consecutively or simultaneously. Simultaneous recording of a plurality of locations (a sensor array) may provide for relative consistency in environmental conditions that may be helpful in ameliorating problematic or localized ambient noise not related to subsurface characteristics of interest. Additionally the array may provide signal differentiation advantages due to commonalities and differences in the recorded signal.

The reverse-time propagation process may include development of an earth model based on a priori knowledge or estimates of physical parameters of a survey area of interest. During data preparation, forward modeling may be useful for anticipating and accounting for known seismic signal or refining the velocity model or functions used for the reverse time processing. Modeling may include accounting for, or the removal of, the near sensor signal contributions due to environmental field effects and noise and, thus, the isolation of those parts of acquired data signals believed to be associated with environmental components being examined. By adapting or filtering the data between successive iterations in the imaging process, predicted signal can be obtained, thus allowing convergence to a structure element indicating whether a reservoir is present within the subsurface.

Time-reverse imaging (TRI) locates sources from acoustic, elastic, EM or optical measurements. It is the process of injecting a time reversed wave field at the recording locations and propagating the wave field through an earth model. A TRM result contains the complete time axis which an observer visually scans through to locate energetic focus locations (e.g., using velocity particle maxima). These focal locations are indicative of the constructive interference of energy at a source location.

However, rather than maintain the time axis, it can be collapsed by applying an imaging condition (IC) to produce a single image in physical space. The chain of operations of propagating a time-reversed wave field through a model and applying an imaging condition is referred to as time-reverse imaging (TRI).

When recording the ambient seismic wave field, multi-component sensors are placed at discrete locations. Therefore, when injecting the data into the model domain, point sources are created at recording locations. After sufficient propagation steps, the full wave field will be approximated. The depth at which the sampled wave field approximates the full wave field is a function of spatial sampling and the velocity model parameters, but is usually 1 to 1.5 times the spatial sampling.

From a multi-component data set, individual propagation modes are extracted from the full wave field. For the isotropic case, two vector identities are required to separate the P- and S-wave modes from the full displacement wave-field u(x, t) at each time step. For two-dimensional models x refers to the spatial dimensions (x, z). Without loss of generality, x can also refer to the 3-dimensional (x, y, z) case. The wave field decomposition step is inserted into the TRI algorithm before applying the imaging condition. Since the curl of the irrotational potential is zero and the divergence of the solenoidal potential is zero, the compressional, Eₚ(x, t), and shear, Eₛ(x, t), kinetic energy densities are Eₚ(x,t)=P(x,t)²=(λ+2μ)(∇·\vec{u}|ₜ)², and Eₛ(x,t)=S(x,t)²=μ(−∇×\vec{u}|ₜ)², where λ and μ are the Lame coefficients. The derivatives are evaluated at each time step, t.

Separating the wave field allows for multiple imaging conditions to be applied based upon the expected source type. These imaging conditions are based on extracting the zero-lag of a cross-correlation along the time axis at every spatial location. The imaging conditions are the zero-lag of the P-wave autocorrelation, Iₚ, the zero-lag of the S-wave autocorrelation, Iₛ, the zero-lag of the P- and S-wave cross-correlation, Iₚₛ, and the zero-lag of the cross-correlation of the P- and S-wave energy densities, Iₑ. These imaging conditions are expressed as: Iₚ(x)=ΣₜP(x,t)P(x,t), I_{S}(x)=ΣₜS(x,t)S(x,t), Iₚₛ(x)=ΣₜP(x,t)S(x,t), and Iₑ(x)=ΣₜEₚ(x,t)Eₛ(x,t).

These image conditions, except for the cross-correlation of the P- and S-waves, have squared the wave field components, and thus produce non-negative images. The cross-correlation of the P- and S-waves has 0-mean, and has a zero-crossing at the source location, which is a function of the source type.

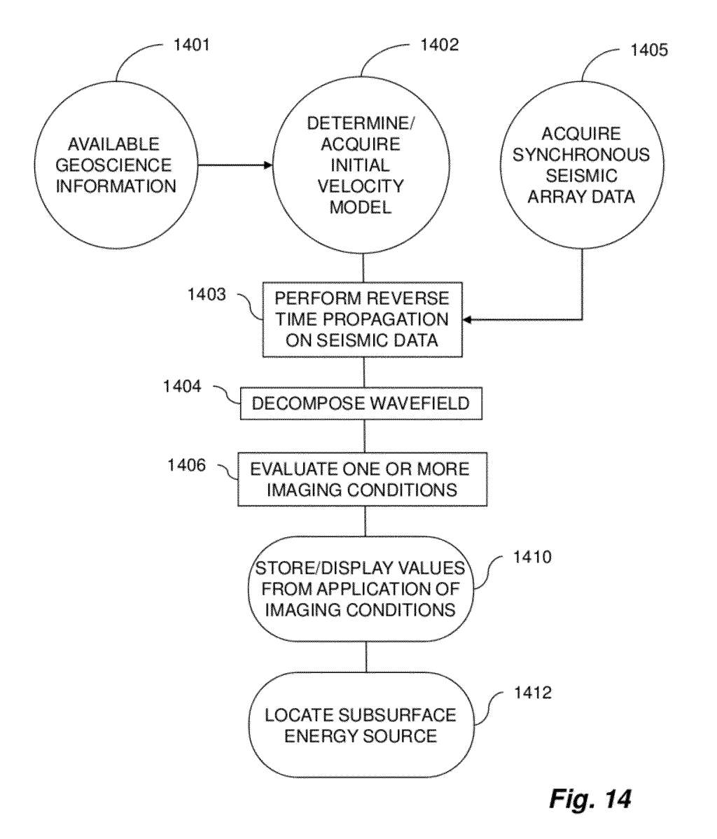

FIG. 14 illustrates an example of reverse-time imaging (TRI) for locating an energy source or a reservoir in the subsurface with seismic data acquired the field using a velocity model 1402 as input. The reverse time propagation is wave equation based. Any available geoscience information 1401 may be used as input to determine parameters for an initial model 1402 that may be modified as input to a reverse-time data propagation process 1403 as more information is available or determined. Synchronously acquired passive seismic data 1405 are input (after any optional processing/conditioning) to the reverse-time propagation process 1403 of the recorded wave field. Particle dynamics such as displacement, velocity or acceleration (or pressure) are determined from the processed data for determining dynamic particle behaviour. After reverse time propagation, an imaging condition 1406 is applied to the model or image nodes. These imaging conditions are one of: PP(0), SS(0), PS(0), autocorrelation of absolute particle velocity (abs²(0)), maximum absolute particle velocity (vₘₐₓ) and the correlation of the energy density fields E_{P}E_{S}(0). Written out differently, these imaging condition may be one or more of: Eₚ(x,t)=P(x,t)²=(λ+2μ)(∇·\vec{u}|ₜ)², Eₛ(x,t)=S(x,t)²=μ(−∇×\vec{u}|ₜ)², Iₚ(x)=ΣₜP(x,t)P(x,t), I_{S}(x)=ΣₜS(x,t)S(x,t), Iₚₛ(x)=ΣₜP(x,t)S(x,t), and Iₑ(x)=ΣₜEₚ(x,t)Eₛ(x,t). The output from the application of the imaging condition is stored 1410 or displayed. The image data output from application of the imaging condition may be used to determine subsurface energy source locations 1412 or reservoir positions.

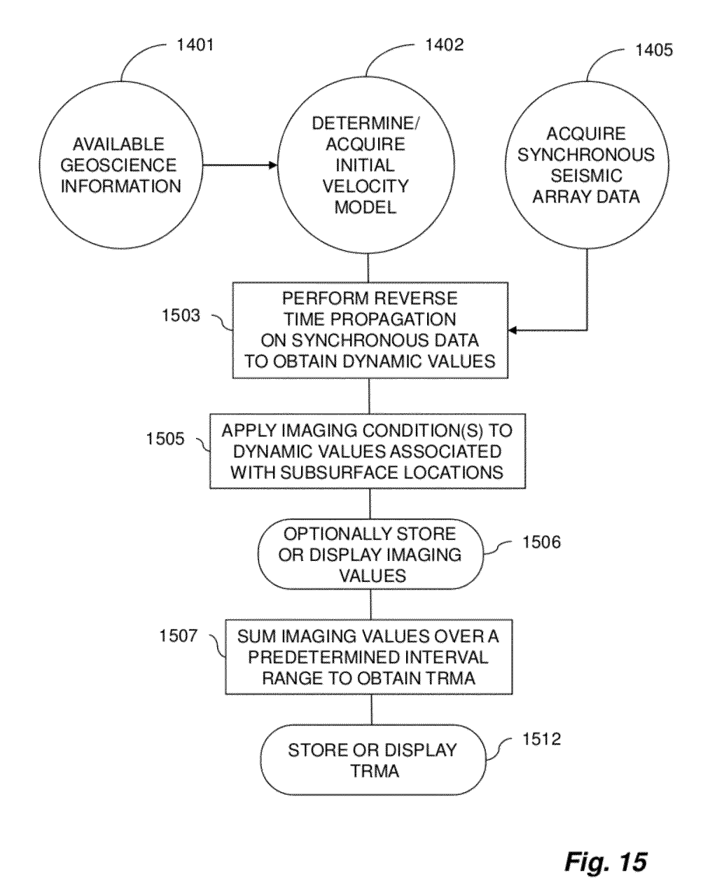

FIG. 15 illustrates an example of a reverse-time propagation process to determine a time reverse imaging attribute (TRIA) useful for locating a reservoir or energy source in the subsurface using a velocity model 1402 as input for a reverse-time imaging. The reverse time imaging may be wave equation based. Any available geoscience information 1401 may be used as input to determine parameters for an initial model 1402 that may be modified as input to reverse-time data propagation 1503 as more information is available or determined. Synchronously acquired seismic data 1405 are input (after any optional processing/conditioning) to the reverse-time data process 1503. One or more imaging conditions are applied to the time-reversed data to obtain imaging values 1505 associated with subsurface locations. These imaging conditions are one of: PP(0), SS(0), PS(0), autocorrelation of absolute particle velocity (abs²(0)), maximum absolute particle velocity (vₘₐₓ) and the correlation of the energy density fields E_{P}E_{S}(0). Written out differently, these imaging condition may be one or more of: Eₚ(x,t)=P(x,t)²=(λ+2μ)(∇·\vec{u}|ₜ)², E_{S}(x,t)=S(x,t)²=μ(−∇×\vec{u}|ₜ)², Iₚ(x)=EₜP(x,t)P(x,t), I_{S}(x)=ΣₜS(x,t)S(x,t), Iₚₛ(x)=ΣₜP(x,t)S(x,t), and Iₑ(x)=ΣₜEₚ(x,t)Eₛ(x,t). The imaging values may optionally be stored or displayed 1506. These output values, which depending on the selected imaging condition may be proportional to energy, are representative over the subsurface volume of the energy that has originated from the associated subsurface location. TRIA is obtained for a selected interval (in time or depth) by summing the values over the selected interval 1507. The TRIA may be projected to the earth surface or a subsurface horizon in association with a surface sensor position or any arbitrary position to provide an indication of areal extent of a subsurface energy source anomaly or hydrocarbon reservoir. The TRIA may be stored or displayed 1512. Alternatively, the TRIA value may be evaluated along a horizon or a depth level.

An example of an embodiment illustrated here uses a numerical modeling algorithm similar to a rotated staggered grid finite-difference technique. The two dimensional numerical grid is rectangular. Computations may be performed with second order spatial explicit finite difference operators and with a second order time update. However, as will be well known by practitioners familiar with the art, many different reverse-time methods may be used along with various wave equation approaches. Extending methods to three dimensions is straightforward.

In one non-limiting embodiment a method and system for processing synchronous array seismic data includes acquiring synchronous passive seismic data from a plurality of sensors to obtain synchronized array measurements. A reverse-time data propagation process is applied to the synchronized array measurements to obtain a plurality of dynamic particle parameters associated with subsurface locations. These dynamic particle parameters are stored in a form for display. Maximum values of the dynamic particle parameters may be interpreted as reservoir locations. The dynamic particle parameters may be particle displacement values, particle velocity values, particle acceleration values or particle pressure values. The sensors may be three-component sensors. Zero-phase frequency filtering of different ranges of interest may be applied. The data may be resampled to facilitate efficient data processing.

A system response is the convolution of a seismic signal with a velocity model. Different velocity models engender different responses to the same seismic input. Particular models may have system responses that obscure the source locations even with high signal to noise ratios. An example is the “ringing” in low velocity layers. The system response to field data will contain contributions from signal, noise and sampling artifacts. To accurately interpret the signal contribution, it is important to estimate and remove the any portion of a system response to non-signal components. A non-signal noise data set may be used to remove non-signal contributions to a system response.

A non-signal noise-dataset may be developed from noise traces from an appropriate noise model containing seismic data scaled to the amplitude and frequency band of the acquired field data. This ensures that the noise traces have equal energy to the recorded traces but without any correlated phase information. The advantage of this type of noise model is that it is based directly on the data. No information about the acquisition environment is necessary. The noise model seismic data may be generated from random input or forward modeling.

Once created, the non-signal noise-dataset is imaged with the TRI algorithm in the same fashion with the same velocity field as the field seismic data. This synthetic image derived using the velocity field will estimate the system response to both the non-signal noise-dataset and sampling artifacts. In this way, it is possible to create an estimate of the signal to noise ratio in the image domain. The recorded data, d, is a combination of signal and noise: d=s+n. The image created from this data is the apparent signal image, S. Using capital letters to indicate images as a function of space, eg S(x) and lower case letters for recordings that functions of space and time, eg d(x, t), the apparent signal for the recorded data is defined as: S=Σₜ(sₜ+nₜ)²=Σₜ²+2sₜnₜ+nₜ², where the time-axis is summed over t. Dropping the subscript, the estimated noise image, Ñ, is Ñ=Σñ², where ñ is the noise data. The estimated signal image, \tilde{S}, is \tilde{S}=S−Ñ.

A signal to noise estimate may be obtained by dividing the apparent signal by the noise estimate. The estimated signal to noise image is

$$\frac{\tilde{S}}{\tilde{N}} + 1 = \frac{S}{\tilde{N}} = \frac{Σ {s}^{2}}{Σ {\tilde{n}}^{2}} + 2 \frac{Σ sn}{Σ {\tilde{n}}^{2}} + \frac{Σ {n}^{2}}{Σ {\tilde{n}}^{2}} .$$

For noise estimated correctly, n≈ñ and

$$\frac{Σ {n}^{2}}{Σ {\tilde{n}}^{2}} \approx 1.$$

Therefore, the division of dataset S with dataset Ñ results in an estimated signal to noise image.

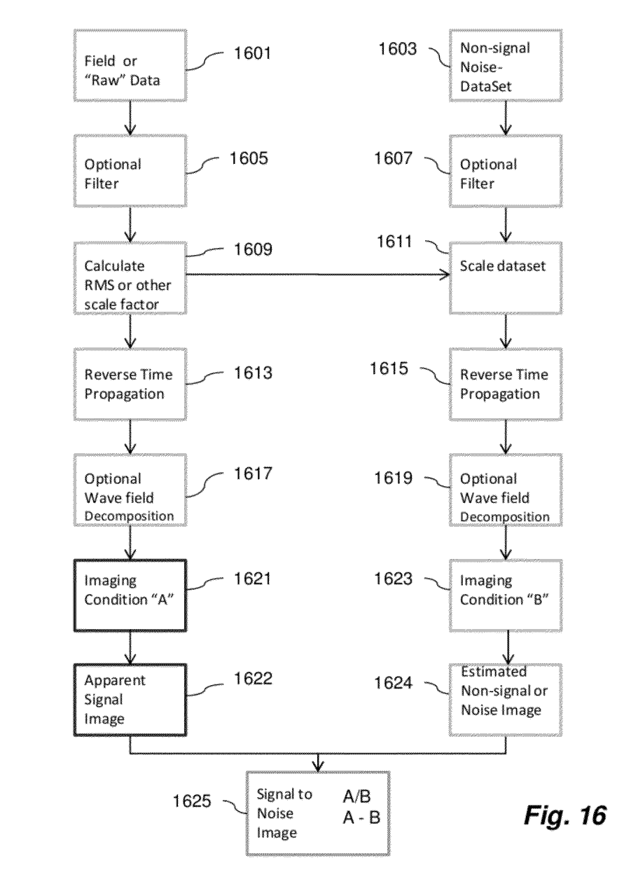

FIG. 16 illustrates a flow chart according to an embodiment of the present disclosure for determining a signal to noise image that includes executing a TRI processing method with acquired seismic data 1601 as input. The method includes estimating or compensating for the signal to noise ratio in the image domain. The process includes two essentially parallel processes including the input of a non-signal noise dataset 1603 containing a substantially equivalent amount of energy and frequency content as the acquired seismic data 1601 at each sensor or acquisition station for all components. The non-signal noise dataset may be developed from substantially random data or a forward modeling process may be used to determine the non-signal noise dataset if parameters are available. When both the real seismic data 1601 and non-signal 1603 data are processed through to an imaging condition result, the images are divided or otherwise compared (e.g., Real image output divided by the non-signal image output) or otherwise processed together to determine where energy originating in the subsurface focuses 1625.

Following a reverse time propagation process similar to FIG. 14, the synchronously acquired seismic array data 1601 may be optionally filtered 1605 or otherwise processed to remove transients and noise. A scaling value (e.g. an RMS value determined from the seismic data) is calculated 1609 that may also be used as an input parameter (1611) for the nonsignal noise dataset sequence processing. Reverse time propagation (which may be referred to as acausal elastic propagation) is applied to the data 1613 (e.g., FIG. 14). Acausal propagation of the data, or causal propagation of time-reversed data, will position the data through time to the location of the source.

Optionally, the wavefield may be decomposed 1617 so that one or more of the imaging conditions referred to above 1621, for example an imaging condition arbitrarily designated “A” that may be one or more of Iₚ, Iₛ, Iₚₛ and/or Iₑ.

Random input seismic data 1603 undergoes a similar processing sequence. The data may be optionally filtered 1607 in the same or equivalent manner to 605 and may be scaled 1611 by the RMS or other scaling value calculated at 609. The data are propagated through the velocity model 1615, as in 1613, and the wavefield decomposed 1619. An imaging condition “B” (that may be imaging condition “A”) is applied to the decomposed data. After application of the selected imaging condition the output is an apparent signal image 1622 or an estimated noise image 1624. The estimated noise image 1624, generated from the non-signal noise dataset, may optionally be smoothed. The data determined at 1622 and 1624 may then be divided or otherwise scaled, for example the data output from 1622 may be divided by the data output from 1624, which results in a signal to noise image 1625. This signal to noise image 1625 may be considered as the effective removal of an image system response related to the velocity model.

Another embodiment according to the present disclosure comprises an image domain stack: After TRM or TRI processing, the image data or dynamic particle values are stacked vertically in time or depth to obtain a TRI attribute (TRIA). The stacking may be over a selected interval of interest or substantially the entire vertical depth or time range of the time reverse imaging. This attribute may be displayed in map form over the area of the seismic data acquisition, which results in the TRIA projected to the surface. This gives a surface map of where the energy is accumulating over the survey area. The data values projected to the surface may be contoured or otherwise processed for display. In some circumstances (for example sparse spatial sampling resulting in strong apparent near surface effects) it may be best to exclude the near surface from the TRIA determination.

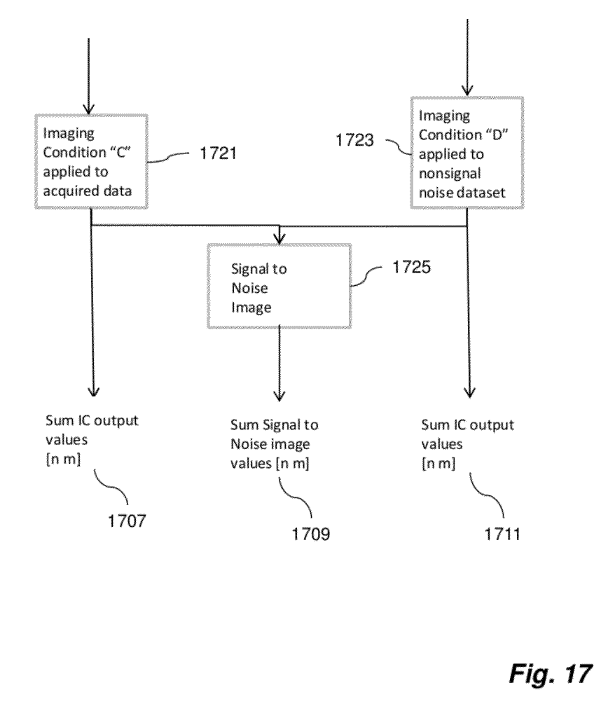

FIG. 17 illustrates that data processed to Imaging Condition “C” 1721 that may, for example, be an imaging condition applied to a decomposed wavefield of acquired seismic data may then be summed 1707 along the depth or time axis. Alternatively, the imaging condition (IC) output may be summed along a horizontal interval or a known horizon interval. Imaging Condition “D” 1723, applied to a non-signal noise dataset, which imaging condition may be equivalent to 1721, but for a non-signal noise dataset or a time separated dataset may be combined with data from 1721 at 1725 to remove the impulse response prior to stacking along the depth axis 1709. The data from 1723 may also be summed 1711 (as in 1707) for comparison as well. These output values may also be projected to the surface and contoured.

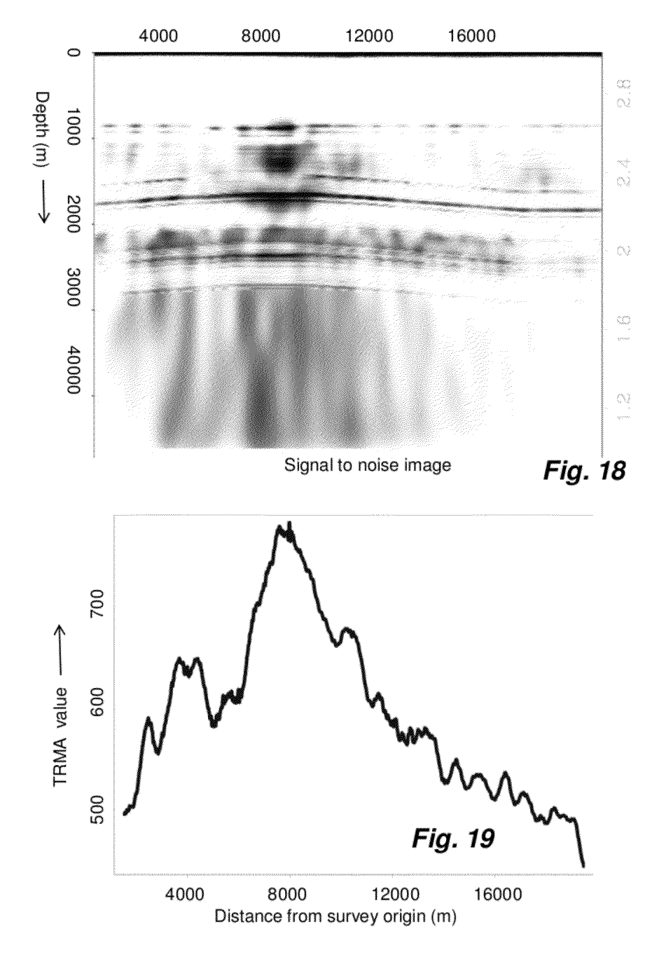

FIG. 18 illustrates a signal to noise image, or an image-domain signal to noise estimate, an example of the output of 1625, the output of the division of a ‘real’ dataset using field acquired seismic data, for example at step 1622, by a dataset from the same location using the non-signal noise dataset input processed to an imaging condition representing an estimate of the noise, for example like 1624 of FIG. 16. The advantage is that energy that may appear to focus in parts of the depth model is accounted for since the enhanced focus of random energy is accounted for in the output of this processing.

FIG. 19 illustrates an example of the TRIA over a surface profile obtained by stacking the data (arbitrary vertical axis units) from the imaging condition result along the vertical axis (depth in this case) of the processing illustrated in FIG. 18. In this case the near surface is not included since the numerical artifacts due to the relatively sparse near surface spatial sampling are strong and do not apparently contain accurate information. Alternatively, the data may be stacked or summed horizontally or along or in depth or time horizons.

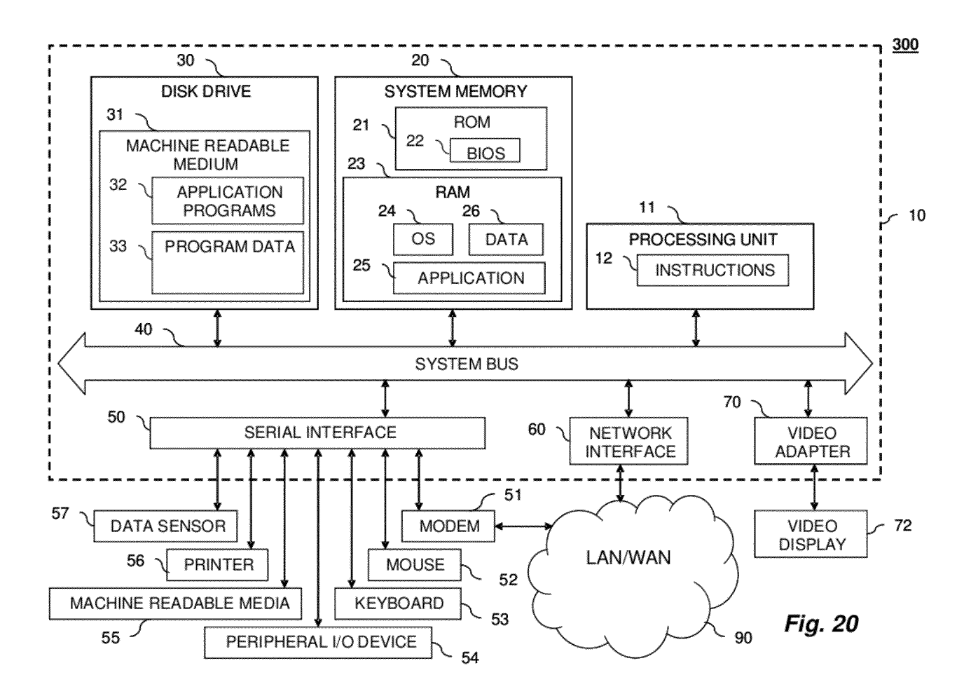

FIG. 20 is illustrative of a computing system and operating environment 300 for implementing a general purpose computing device in the form of a computer 10. Computer 10 includes a processing unit 11 that may include ‘onboard’ instructions 12. Computer 10 has a system memory 20 attached to a system bus 40 that operatively couples various system components including system memory 20 to processing unit 11. The system bus 40 may be any of several types of bus structures using any of a variety of bus architectures as are known in the art.

While one processing unit 11 is illustrated in FIG. 20, there may be a single central-processing unit (CPU) or a graphics processing unit (GPU), or both or a plurality of processing units. Computer 10 may be a standalone computer, a distributed computer, or any other type of computer.

System memory 20 includes read only memory (ROM) 21 with a basic input/output system (BIOS) 22 containing the basic routines that help to transfer information between elements within the computer 10, such as during start-up. System memory 20 of computer 10 further includes random access memory (RAM) 23 that may include an operating system (OS) 24, an application program 25 and data 26.

Computer 10 may include a disk drive 30 to enable reading from and writing to an associated computer or machine readable medium 31. Computer readable media 31 includes application programs 32 and program data 33.

For example, computer readable medium 31 may include programs to process seismic data, which may be stored as program data 33, according to the methods disclosed herein. The application program 32 associated with the computer readable medium 31 includes at least one application interface for receiving and/or processing program data 33. The program data 33 may include seismic data acquired according to embodiments disclosed herein. At least one application interface may be associated with determining one or more imaging conditions for locating subsurface hydrocarbon reservoirs.

The disk drive may be a hard disk drive for a hard drive (e.g., magnetic disk) or a drive for a magnetic disk drive for reading from or writing to a removable magnetic media, or an optical disk drive for reading from or writing to a removable optical disk such as a CD ROM, DVD or other optical media.

Disk drive 30, whether a hard disk drive, magnetic disk drive or optical disk drive is connected to the system bus 40 by a disk drive interface (not shown). The drive 30 and associated computer-readable media 31 enable nonvolatile storage and retrieval for application programs 32 and data 33 that include computer-readable instructions, data structures, program modules and other data for the computer 10. Any type of computer-readable media that can store data accessible by a computer, including but not limited to cassettes, flash memory, digital video disks in all formats, random access memories (RAMs), read only memories (ROMs), may be used in a computer 10 operating environment.

Data input and output devices may be connected to the processing unit 11 through a serial interface 50 that is coupled to the system bus. Serial interface 50 may a universal serial bus (USB). A user may enter commands or data into computer 10 through input devices connected to serial interface 50 such as a keyboard 53 and pointing device (mouse) 52. Other peripheral input/output devices 54 may include without limitation a microphone, joystick, game pad, satellite dish, scanner or fax, speakers, wireless transducer, etc. Other interfaces (not shown) that may be connected to bus 40 to enable input/output to computer 10 include a parallel port or a game port. Computers often include other peripheral input/output devices 54 that may be connected with serial interface 50 such as a machine readable media 55 (e.g., a memory stick), a printer 56 and a data sensor 57. A seismic sensor or seismometer for practicing embodiments disclosed herein is a nonlimiting example of data sensor 57. A video display 72 (e.g., a liquid crystal display (LCD), a flat panel, a solid state display, or a cathode ray tube (CRT)) or other type of output display device may also be connected to the system bus 40 via an interface, such as a video adapter 70. A map display created from spectral ratio values as disclosed herein may be displayed with video display 72.

A computer 10 may operate in a networked environment using logical connections to one or more remote computers. These logical connections are achieved by a communication device associated with computer 10. A remote computer may be another computer, a server, a router, a network computer, a workstation, a client, a peer device or other common network node, and typically includes many or all of the elements described relative to computer 10. The logical connections depicted in FIG. 20 include a local-area network (LAN) or a wide-area network (WAN) 90. However, the designation of such networking environments, whether LAN or WAN, is often arbitrary as the functionalities may be substantially similar. These networks are common in offices, enterprise-wide computer networks, intranets and the Internet.

When used in a networking environment, the computer 10 may be connected to a network 90 through a network interface or adapter 60. Alternatively computer 10 may include a modem 51 or any other type of communications device for establishing communications over the network 90, such as the Internet. Modem 51, which may be internal or external, may be connected to the system bus 40 via the serial interface 50.

In a networked deployment computer 10 may operate in the capacity of a server or a client user machine in server-client user network environment, or as a peer machine in a peer-to-peer (or distributed) network environment. In a networked environment, program modules associated with computer 10, or portions thereof, may be stored in a remote memory storage device. The network connections schematically illustrated are for example only and other communications devices for establishing a communications link between computers may be used.

In one nonlimiting embodiment a method for processing synchronous array seismic data comprises acquiring seismic data from a plurality of sensors to obtain synchronized array measurements. A reverse-time data propagation process is applied to the synchronized array measurements to obtain dynamic particle parameters associated with subsurface locations. At least one imaging condition is applied, using a processing unit, to the dynamic particle parameters to obtain imaging values associated with subsurface locations and subsurface positions of an energy source are located from the imaging values associated with subsurface locations.

In other aspects the method further comprises storing the imaging values associated with subsurface locations in a form for display. Synchronized array measurements are selected for input to the reverse-time data propagation process without reference to phase information of the seismic data. The synchronized array measurements may be at least one selected from the group comprising i) particle velocity measurements, ii) particle acceleration measurements, iii) particle pressure measurements and iv) particle displacement measurements. The plurality of sensors are three-component sensors. In another aspect, the at least one imaging condition is at least one selected from the group consisting of; i) the zero-lag of the P-wave autocorrelation, ii) the zero-lag of the S-wave autocorrelation, iii) the zero-lag of the cross-correlation of the P- and S-wave energy densities, iv) autocorrelation of the absolute value of particle motion, v) maximum over all time, and vi) the crosscorrelation of the energy density functions E_{P}E_{S}. Alternatively the method comprises applying the group of imaging conditions consisting of; i) the zero-lag of the P-wave autocorrelation, ii) the zero-lag of the S-wave autocorrelation, iii) the zero-lag of the cross-correlation of the P- and S-wave energy densities, iv) autocorrelation of the absolute value of particle motion, v) maximum over all time, and vi) the crosscorrelation of the energy density functions E_{P}E_{S}.

In another nonlimiting embodiment a set of application program interfaces is embodied on a computer readable medium for execution on a processor in conjunction with an application program for applying a reverse-time data process to synchronized seismic data array measurements to obtain a subsurface image values associated with subsurface energy source locations comprising a first interface that receives synchronized seismic data array measurements and a second interface that receives a plurality of dynamic particle parameters associated with a subsurface location, the parameters output from reverse-time data processing of the synchronized seismic data array measurements. Also included is a third interface that receives instruction data for applying at least one imaging condition to the dynamic particle parameters to obtain image values associated with subsurface energy source locations. A fourth interface receives instruction data for storing, on a computer readable medium, image values associated with subsurface energy source locations.

Other aspects include the set of application interface programs further comprising a display interface that receives instruction data for displaying image values associated with subsurface energy source locations. The set of application interface programs also comprises a velocity-model interface that receives instruction data for reverse-time propagation using a velocity structure associated with the synchronized seismic data array measurements. The set of application interface programs also comprises a migration-extrapolator interface that receives instruction data for including an extrapolator for at least one selected from the group of i) finite-difference time reverse migration, ii) ray-tracing reverse time migration and iii) pseudo-spectral reverse time migration. Further, the set of application interface programs also comprises an imaging-condition interface that receives instruction data for applying an imaging condition selected from the group consisting of; i) the zero-lag of the P-wave autocorrelation, ii) the zero-lag of the S-wave autocorrelation, iii) the zero-lag of the cross-correlation of the P- and S-wave energy densities, iv) autocorrelation of the absolute value of particle motion, v) maximum over all time, and vi) the crosscorrelation of the energy density functions E_{P}E_{S}. Alternatively, the set of application interface programs also comprises an imaging-suite interface that receives instruction data for applying the group of imaging conditions consisting of: i) the zero-lag of the P-wave autocorrelation, ii) the zero-lag of the S-wave autocorrelation, iii) the zero-lag of the cross-correlation of the P- and S-wave energy densities, iv) autocorrelation of the absolute value of particle motion, v) maximum over all time, and vi) the crosscorrelation of the energy density functions E_{P}E_{S}. The set of application interface programs also comprises a seismic-data-input interface that receives instruction data for the input of the plurality of seismic data array measurements that are at least one selected from the group consisting of i) particle velocity measurements, and ii) particle acceleration measurements, iii) particle pressure measurements and iv) displacement measurements.

In still another non limiting embodiment, an information handling system for determining subsurface image values associated with subsurface energy source locations associated with an area of seismic data acquisition comprises a processor configured for applying a reverse-time data process to synchronized array measurements of seismic data to obtain dynamic particle parameters associated with subsurface locations and a processor configured for applying at least one imaging condition to the dynamic particle parameters associated with subsurface locations to obtain image values associated with subsurface energy source locations, as well as a computer readable medium for storing the image values associated with subsurface energy source locations.

In another aspect the information handling system includes a processor configured to apply the reverse-time data process with a velocity model comprising predetermined subsurface velocity information associated with subsurface locations. The information handling system further comprises a display device for displaying the image values associated with subsurface energy source locations. Also the information handling system determining the image values associated with subsurface energy source locations that are obtained using an imaging condition that is at least one selected from the group consisting of: i) the zero-lag of the P-wave autocorrelation, ii) the zero-lag of the S-wave autocorrelation, iii) the zero-lag of the cross-correlation of the P- and S-wave energy densities, iv) autocorrelation of the absolute value of particle motion, v) maximum over all time, and vi) the crosscorrelation of the energy density functions E_{P}E_{S}. Alternatively, the processor of information handling system is configured to apply the reverse-time data process with an extrapolator for at least one selected from the group of i) finite-difference reverse time migration, ii) ray-tracing reverse time migration and iii) pseudo-spectral reverse time migration. Finally, the information handling system of claim 15 further comprises a graphical display coupled to the processor and configured to present a view of the image values associated with subsurface energy source locations, wherein the processor is configured to generate the view by contouring values of the image values associated with subsurface energy source locations over an area associated with the seismic data.

While various embodiments have been shown and described, various modifications and substitutions may be made thereto without departing from the spirit and scope of the disclosure herein. Accordingly, it is to be understood that the present embodiments have been described by way of illustration and not limitation.

We claim:

1-20. (canceled)

21. A method for processing synchronous array seismic data comprising:
a) acquiring seismic data from a plurality of sensors positioned in a borehole to obtain synchronized array measurements;
b) applying a reverse-time data propagation process to the synchronized array measurements to obtain dynamic particle parameters associated with subsurface locations; and
c) applying at least one imaging condition, using a processing unit, to the dynamic particle parameters to obtain imaging values associated with subsurface locations; and
d) locating a subsurface position of an energy source from the imaging values associated with subsurface locations.

22. The method of claim 1 further comprising acquiring the synchronized array measurements with a three dimensional surface sensor array.

23. The method of claim 1 further comprising selecting synchronized array measurements for input to the reverse-time data propagation process without reference to phase information of the seismic data;

24. The method of claim 1 wherein the synchronized array measurements are at least one selected from the group consisting of i) particle velocity measurements, ii) particle acceleration measurements, iii) particle pressure measurements and iv) particle displacement measurements.

25. The method of claim 1 wherein the plurality of sensors are three-component sensors.

26. The method of claim 1 wherein the at least one imaging condition is at least one selected from the group consisting of; i) the zero-lag of the P-wave autocorrelation, ii) the zero-lag of the S-wave autocorrelation, iii) the zero-lag of the cross-correlation of the P- and S-wave energy densities, iv) autocorrelation of the absolute value of particle motion, v) maximum over all time, and vi) the crosscorrelation of the energy density functions E_{P}E_{S}.

27. The method of claim 1 further comprising applying the group of imaging conditions consisting of; i) the zero-lag of the P-wave autocorrelation, ii) the zero-lag of the S-wave autocorrelation, iii) the zero-lag of the cross-correlation of the P- and S-wave energy densities, iv) autocorrelation of the absolute value of particle motion, v) maximum over all time, and vi) the crosscorrelation of the energy density functions E_{P}E_{S}.

28. A set of application program interfaces embodied on a computer readable medium for execution on a processor in conjunction with an application program for applying a reverse-time data process to synchronized seismic data array measurements to obtain a subsurface image values associated with subsurface energy source locations comprising:
a first interface that receives synchronized seismic data array measurements from sensors positioned in a borehole;
a second interface that receives a plurality of dynamic particle parameters associated with a subsurface location, the parameters output from reverse-time data processing of the synchronized seismic data array measurements; and
a third interface that receives instruction data for applying at least one imaging condition to the dynamic particle parameters to obtain image values associated with subsurface energy source locations; and
a fourth interface that receives instruction data for storing, on a computer readable medium, image values associated with subsurface energy source locations.

29. The set of application interface programs according to claim 8 further comprising:
a sensor-data input interface that receives synchronized seismic data array measurements acquired with a three dimensional surface sensor array.

30. The set of application interface programs according to claim 8 further comprising:
a velocity-model interface that receives instruction data for reverse-time propagation using a velocity structure associated with the synchronized seismic data array measurements.

31. The set of application interface programs according to claim 8 further comprising:
a migration-extrapolator interface that receives instruction data for including an extrapolator for at least one selected from the group of i) finite-difference time reverse migration, ii) ray-tracing reverse time migration and iii) pseudo-spectral reverse time migration.

32. The set of application interface programs according to claim 8 further comprising:
an imaging-condition interface that receives instruction data for applying an imaging condition selected from the group consisting of; i) the zero-lag of the P-wave autocorrelation, ii) the zero-lag of the S-wave autocorrelation, iii) the zero-lag of the cross-correlation of the P- and S-wave energy densities, iv) autocorrelation of the absolute value of particle motion, v) maximum over all time, and vi) the crosscorrelation of the energy density functions E_{P}E_{S}.

33. The set of application interface programs according to claim 8 further comprising:
an imaging-suite interface that receives instruction data for applying the group of imaging conditions consisting of: i) the zero-lag of the P-wave autocorrelation, ii) the zero-lag of the S-wave autocorrelation, iii) the zero-lag of the cross-correlation of the P- and S-wave energy densities, iv) autocorrelation of the absolute value of particle motion, v) maximum over all time, and vi) the crosscorrelation of the energy density functions E_{P}E_{S}.

34. The set of application interface programs according to claim 8 further comprising:
a seismic-data-input interface that receives instruction data for the input of the plurality of seismic data array measurements that are at least one selected from the group consisting of i) particle velocity measurements, and ii) particle acceleration measurements, iii) particle pressure measurements and iv) displacement measurements.

35. An information handling system for determining subsurface image values associated with subsurface energy source locations associated with an area of seismic data acquisition comprising:
a) a processor configured for applying a reverse-time data process to synchronized array measurements of seismic data acquired with sensors positioned in a borehole to obtain dynamic particle parameters associated with subsurface locations;
b) a processor configured for applying at least one imaging condition to the dynamic particle parameters associated with subsurface locations to obtain image values associated with subsurface energy source locations; and
c) a computer readable medium for storing the image values associated with subsurface energy source locations.

36. The information handling system of claim 15 wherein the processor is configured to apply the reverse-time data process with a velocity model comprising predetermined subsurface velocity information associated with subsurface locations.

37. The information handling system of claim 15 wherein the processor is further configured for applying a reverse-time data process to synchronized array measurements of seismic data acquired with a three dimensional surface sensor array to obtain dynamic particle parameters associated with subsurface locations.

38. The information handling system of claim 15 wherein the image values associated with subsurface energy source locations are obtained from an imaging condition that is at least one selected from the group consisting of: i) the zero-lag of the P-wave autocorrelation, ii) the zero-lag of the S-wave autocorrelation, iii) the zero-lag of the cross-correlation of the P- and S-wave energy densities, iv) autocorrelation of the absolute value of particle motion, v) maximum over all time, and vi) the crosscorrelation of the energy density functions E_{P}E_{S}.

39. The information handling system of claim 15 wherein the processor is configured to apply the reverse-time data process with an extrapolator for at least one selected from the group of i) finite-difference reverse time migration, ii) ray-tracing reverse time migration and iii) pseudo-spectral reverse time migration.

40. The information handling system of claim 15 further comprising:
a graphical display coupled to the processor and configured to present a view of the image values associated with subsurface energy source locations, wherein the processor is configured to generate the view by contouring values of the image values associated with subsurface energy source locations over an area associated with the seismic data.
